(19) United States
(12) Patent Application Publication
(10) Pub. No.: US 2024/0145988 A1
(43) Pub. Date: May 2, 2024

(54) CONNECTOR ASSEMBLY

(71) Applicant: LIQUN JIANG, SHENZHEN (CN)

(72) Inventors: Jie Li, Luzhou (CN); Da Teng, Shanghai (CN)

(21) Appl. No.: 18/132,172

(22) Filed: Apr. 7, 2023

(30) Foreign Application Priority Data
Oct. 28, 2022 (CN) 202222857611.0

(51) Int. Cl. H01R 13/627; H01R 13/73; H01R 33/945

(52) U.S. Cl. CPC H01R 13/627; H01R 13/73; H01R 33/945

(57) ABSTRACT

The present disclosure provides a connector assembly, which includes a first connector, a fixed connector, an electric connector, and an second connector, wherein the first connector is fixedly connected to an electrical connector, the fixed connector is clamped between the first connector and the electrical connector, and the second connector is arranged at a bottom of the electrical connector and clamped with the electrical connector, an first via hole, a second via hole, an third via hole and an second hole are respectively arranged in a middle of the first connector, the fixed connector, the electrical connector and the second connector, and an air inlet and outlet channel is formed by the cooperation of the first via hole, the second via hole, the third via hole and the second hole, a first end of the second connector is configured for being connected to a connecting pipeline.

### CROSS-REFERENCE TO RELATED APPLICATIONS

This application claims the benefit of priority to Chinese Patent Application Number 202222857611.0 filed on Oct. 28, 2022, in the China National Intellectual Property Administration. The entire contents of the above-identified application are hereby incorporated by reference.

### TECHNICAL FIELD

The disclosure relates to the field of household electric devices, in particular to a connector assembly.

### BACKGROUND

In actual use, when a machine is connected to another machine by a pipeline, the two machines often share a same electric control device to reduce costs. Therefore, an electrical wiring is also required. However, if the pipeline and the electrical wiring are separately connected to each machine, various accessories may be needed, which may be troublesome in use.

When shaving hair of a pet, there are three steps: shaving the pet, bathing the pet, and drying the hair of the pet. An existing pet shaver, absorbs and stores the shaved hair through a device such as a vacuum cleaner while shaving pets, so that the shaved hair will not affect the surrounding environment, thereby making the pet shaver more suitable for household use. However, the connection between a suction device and a shaving device of the pet shaver not only need a hose that allows the shaved hair to pass through, but also need an electric wiring that electrically connects the suction device and the shaving device together. The electric wiring and the hose formed at the same time is a desirable process.

### SUMMARY

To overcome the above-short comings, a connector assembly is needed, which can simultaneously realize electrical connection and pipeline connection without interference.

The present disclosure provides a connector assembly configured connecting pipeline, and electrically connect the device to an electrical connection wire, the device comprising a pipeline interface and an electric interface, comprising: a first connector having an end configured to connect to the pipeline interface and electrically connect to the electric interface, a fixed connector, an electric connector configured to be connected to the electrical connection wire, and a second connector, a first end of the second connector being configured to connect to the connecting pipeline, wherein the first connector is fixed to the electrical connector, the fixed connector is clamped between the first connector and the electrical connector, and a second end of the second connector is arranged at an end of the electrical connector and clamped with the electrical connector, a first via hole, a second via hole, a third via hole, and a fourth via hole are defined in the first connector, the fixed connector, the electrical connector and the second connector, respectively, the first via hole, the second via hole, the third via hole, and the fourth via hole cooperatively form a gas channel.

In some embodiments, an end of the first connector is provided with a connection ring and a connection plate, a first groove is defined on a side of the connection ring away from the connection plate, and a second groove is provided on a side of the connection plate away from the connection ring, the first connector is configured to be fixedly clamped with the device through the first groove and the second groove.

In some embodiments, the connection ring is further provided with a positioning bump.

The connector assembly according to claim 1, wherein the first connector further comprises a snap groove, the snap groove is L-shaped, an inner side surface of the fixed connector is provided with a fixed block engaged with the snap groove.

In some embodiments, a bottom surface of the fixed connector comprises at least one installation member, the electrical connector is defined with at least one fixed slot, the at least one fixed slot is engaged with the installation member.

In some embodiments, an electrical groove is defined between the connection ring and the connection plate, an electrical connection contact for electrically connecting the connector to the device is arranged in the electrical groove.

In some embodiments, wherein the first connector comprises a mounting wall and a pair of plugs disposed on the mounting wall, the pair of plugs are configured to connect to the electrical connection contact, two electrical recesses are provided on the electrical connector, the pair of plugs are inserted into the electrical recess.

In some embodiments, two cantilevers are oppositely arranged on a bottom of the electrical connector, a second connector groove is defined on a side of the second connector, and the second connector groove is engaged with the two cantilevers.

In some embodiments, the second connector comprises an inner wall and an internal thread defined on an end of the inner wall.

In some embodiments, the second connector comprises an inner wall and an internal thread defined on an end of the inner wall.

The beneficial effects of the connector of the present disclosure are described below.

1. By separating the electrical connection channel from the gas outlet channel, the objects passing through the pipeline can be prevented from affecting the electrical connection channel, thus improving the safety of use

2. At the same time, electric connection channel and gas outlet channel are set to realize the design purpose of electric connection and pipeline connection without mutual interference.

### BRIEF DESCRIPTION OF DRAWINGS

Implementations of the present disclosure will now be described, by way of embodiment, with reference to the attached figures.

FIG. 1 is a diagrammatic view of a connector assembly according to an embodiment of the present disclosure.

FIG. 2 is an exploded view of the connector assembly of FIG. 1.

FIG. 3 is a diagrammatic view of a first connector of the connector assembly of FIG. 2.

FIG. 4 is similar to FIG. 3, but showing the first connector from another angle.

FIG. 5 is similar to FIG. 3, but showing the first connector from another angle.

FIG. 6 is a diagrammatic view of a fixed connector of the connector assembly of FIG. 2.

FIG. 7 is a diagrammatic view of an electrical connector of the connector assembly of FIG. 2.

FIG. 8 is similar to FIG. 7, but showing the electrical connector from another angle.

FIG. 9 is a diagrammatic view of a second connector of the connector assembly of FIG. 2.

FIG. 10 is a diagrammatic view showing the connector assembly of FIG. 1 being connected to a first device and a second device.

FIG. 11 is a partial structural diagram at XI of FIG. 10, but does not include connecting pipeline.

FIG. 12 is a diagrammatic view of the first device of FIG. 10.

FIG. 13 is a front view of the first device of FIG. 10.

### DETAILED DESCRIPTION

It should be understood that the embodiments described herein are only intended to explain the present disclosure, but not to limit the present disclosure.

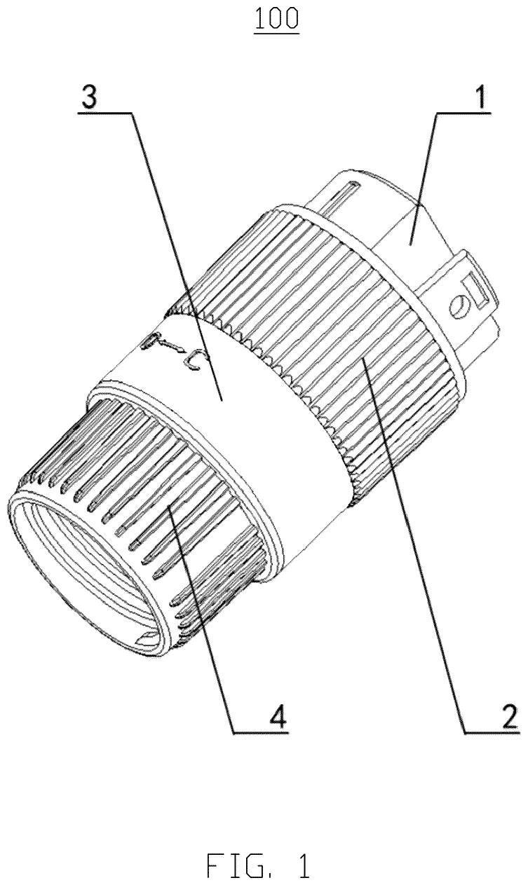

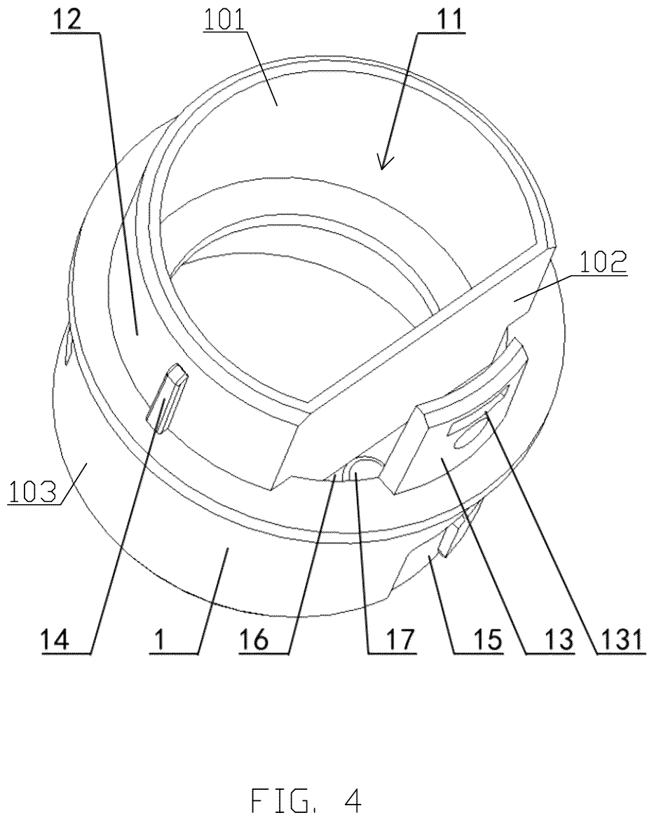

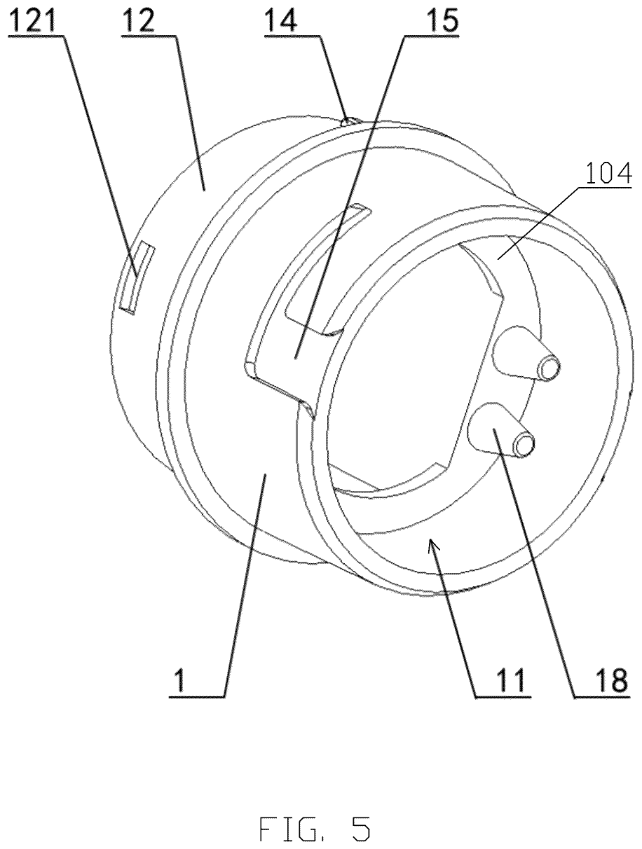

A connector assembly 100 according to the present disclosure will now be described with reference to FIG. 1 to FIG. 9. The connector assembly 100 forms a gas channel and an electrical connection channel, the gas channel is configured for exhausting gas or entering gas, the electrical connection channel is configured for realizing electrical connection, and the electrical connection channel and the gas channel are divided into two parts.

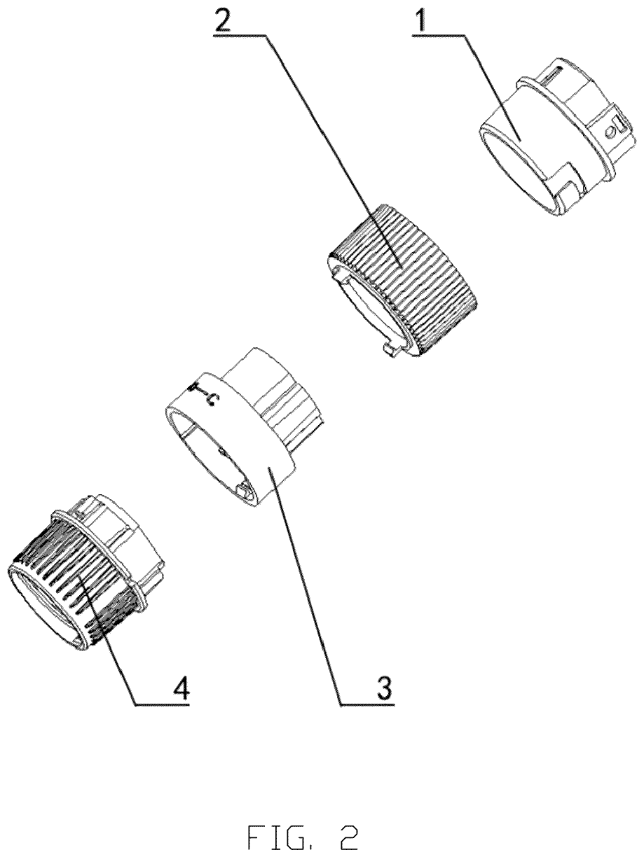

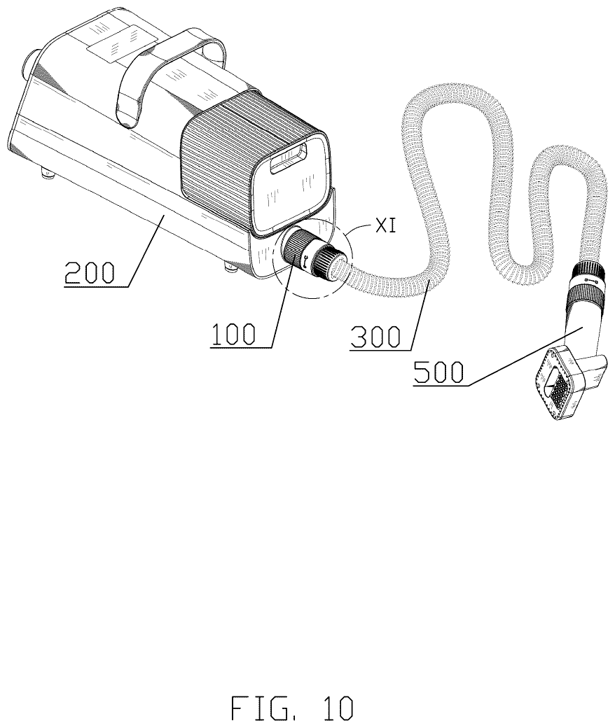

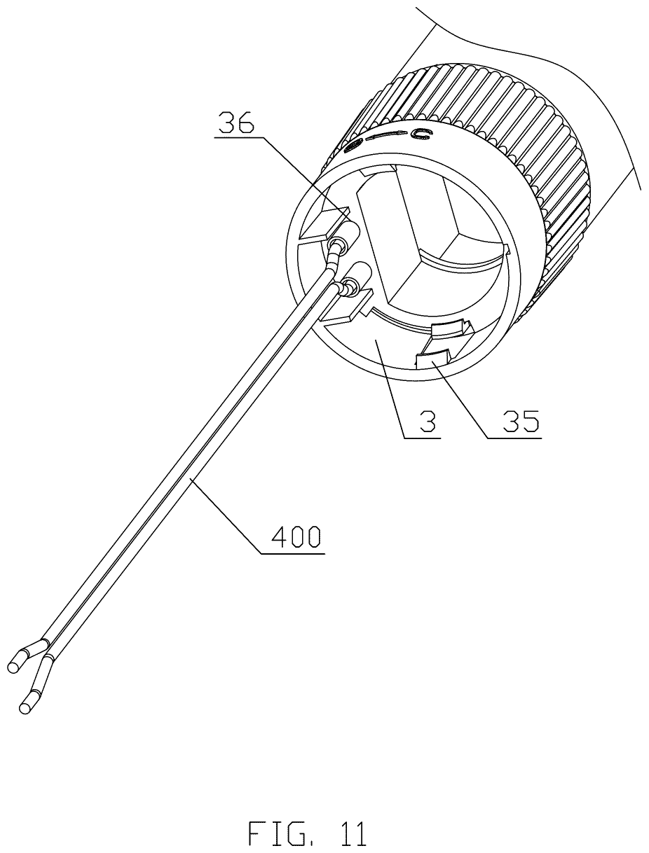

As illustrated in FIG. 1 and FIG. 2, the connector assembly 100 includes a first connector 1, a fixed connector 2, an electrical connector 3, and a second connector 4. The first connector 1, the fixed connector 2, the electrical connector 3, and the second connector 4 are stacked in order in an axial direction of the connector assembly 100. Specifically, the first connector 1 and the electrical connector 3 are embedded at both ends of the fixed connector 2 respectively, and the second connector 4 is embedded at embedded at the end of the electrical connector 3 away from the fixed connector 2. As illustrated in FIG. 10 and FIG. 11, the connector assembly 100 is configured to connect a first device 200 to one end of a connecting pipeline 300, and electrically connect the first device 200 to one end of an electrical connection wire 400, the first device 200 comprising a pipeline interface 210 and an electric interface 211. Another end of the connecting pipeline 300 is connected another connector assembly 100 which connected to a second device 500. In this way, the first device 200 and the second device 500 can be connected by the connecting pipeline 300 and electrically connected by the electrical connection wire 400. The first device 200 and the second device 500 can be the same device or different devices, and there is no restriction here. In one embodiment, the first device 200, the second device 500, the connector assembly 100, the connecting pipeline 300 and the electrical connection wire 400 constitute a vacuum cleaner.

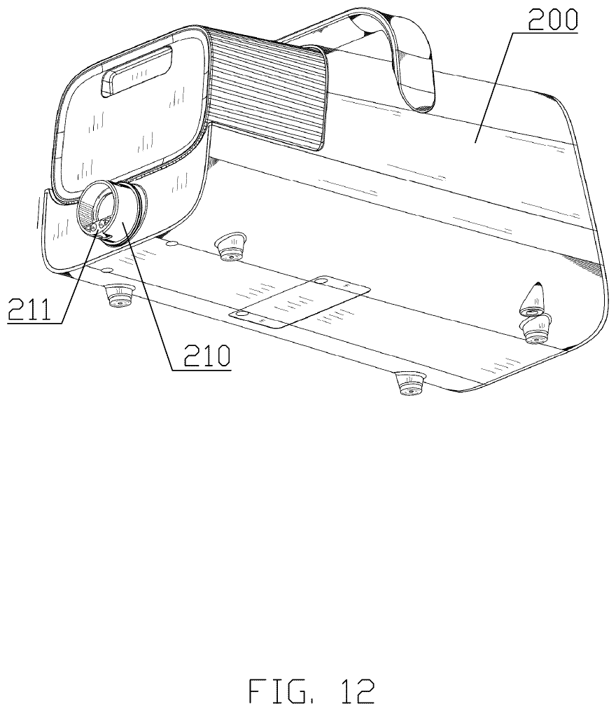

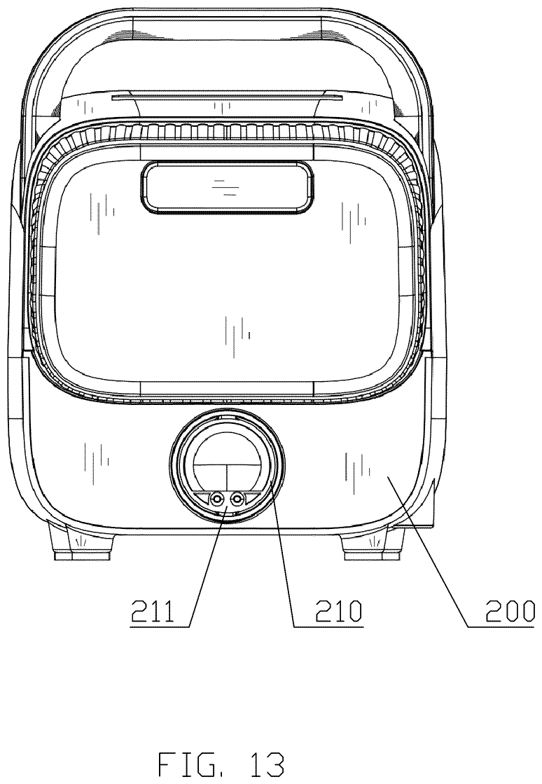

As illustrated in FIG. 12 to FIG. 13, the first connector 1 is configured for connecting to the pipeline interface 210 first device 200 and being electrically connected to the electric interface 211 of the first device 200. The second connector 4 is configured for connecting to the connecting pipeline 300.

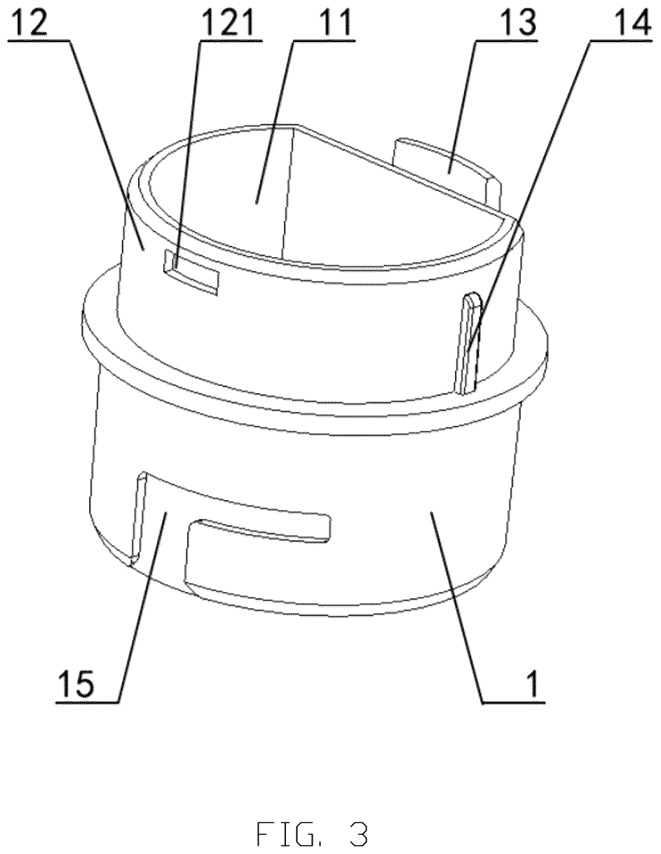

As illustrated in FIG. 3 to FIG. 5, the first connector 1 has an end configured to connect to the pipeline interface 210 and electrically connect to the electric interface 211, the end has a fixing structure on an outer surface thereof, and a first via hole 11 is defined in the first connector 1, the fixing structure includes a connecting ring 12 and a connection plate 13. The connection ring 12 comprises an arc wall 101 and a plane wall 102, the plane wall 102 and connection plate 13 are separated and set relative to each other. A first groove 121 is defined on one side of the arc wall 101 away from the connection plate 13, and a second groove 131 is defined on one side surface of the connection plate 13 away from the connection ring 12. The first connector 1 is configured to be fixedly clamped with the first device 200 by the first groove 121 and the second groove 131. As illustrated in FIG. 10 and FIG. 11, the first device 200 has an external structure to fit with the fixing structure to connect the first connector 1 and the first device 200. In addition, a positioning bump 14 for accurate positioning during mounting is further arranged on a side surface of the arc wall 101.

The first connector 1 further comprises a first embedded portion 103, the first embedded portion 103 is annular, and a snap groove 15 is defined on the first embedded portion 103, and the snap groove 15 is arranged on the same side as the connection plate 13. Seen from the side of the connection ring 12 to the other side, the snap groove 15 is roughly inverted L-shaped.

In addition, the first connector 1 further comprises an mounting wall 104, an electrical groove 16 is defined on one surface facing the connection ring 12 of the mounting wall 104 and arranged between the connection ring 12 and the connection plate 13, an electrical connection contact 17 for electrically connecting the connector 100 to the structure is arranged in the electrical groove 16, and a pair of plugs 18 connected to the electrical connection contact 17 is disposed on another surface of the mounting wall 104.

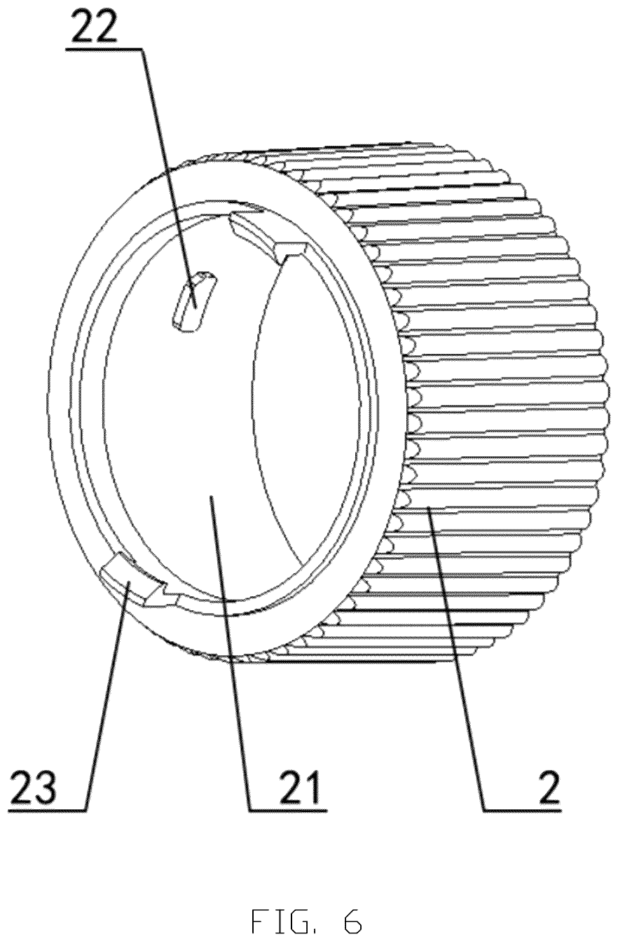

As illustrated in FIG. 6, a second via hole 21 is set in a way of through the fixed connector 2, a fixed block 22 coupled to the snap groove 15 is arranged on an inner side surface of the fixed connector 2. The first embedded portion 103 is inserted into the second via hole 21, and the first connector 1 is snap-fitted with the fixed connector 2 by matching the fixed block 22 with the snap groove 15. An end far away from the first connector 1 of the fixed connector 2 is provided with two installation members 23 opposite to each other. Of course, the number of the installation members 23 is not limited to this.

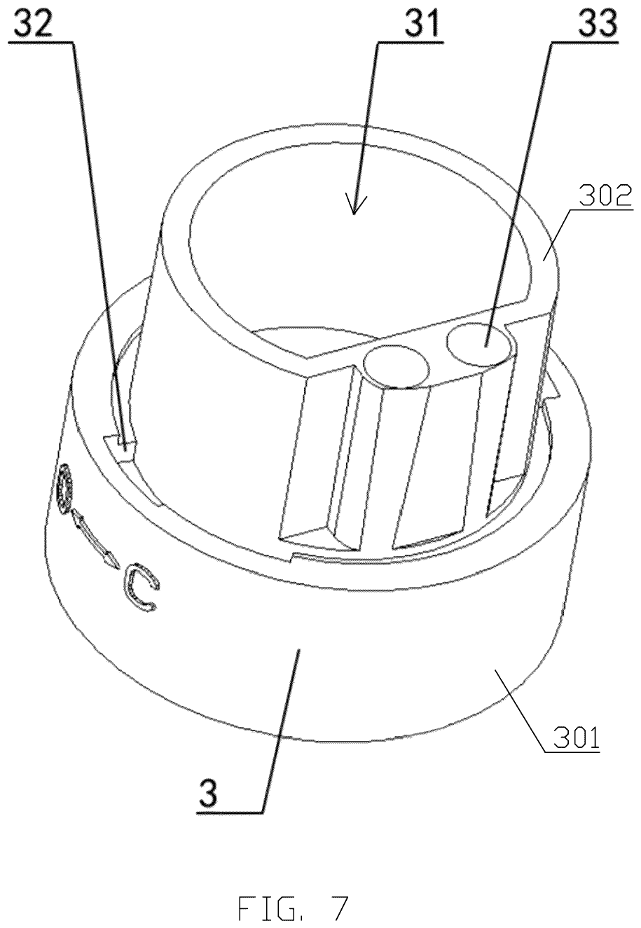

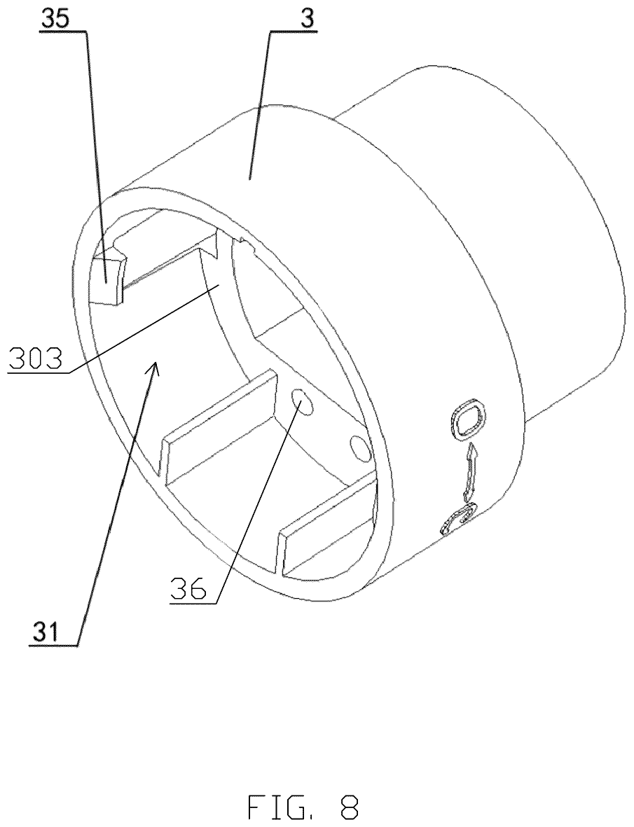

As illustrated in FIG. 7 and FIG. 8, the electrical connector 3 comprises a fixed portion 301 and a second embedded portion 302, the fixed portion 301 and the second embedded portion 302 are arranged in axial direction and connected by a connecting wall 303. In the assembled state, the second embedded portion 302 is inserted to the fixed connector 2, and the fixed portion 301 is exposed outside.

A third via hole 31 is defined on the electrical connector 3, a pair of fixed slots 32 is defined on the fixed portion 301, the pair of fixed slots 32 are engaged with the installation members 23, so that the fixed connector 2 is engaged with the electrical connector 3. A pair of electrical recesses 33 engaged with the pair of plugs 18 are provided on an end away from the fixed portion 301 of the second embedded portion 302, the pair of plugs 18 are inserted into the electrical recess 33 for limiting and fixing. Two cantilevers 35 are arranged at the bottom of the inner wall of the fixed portion 301.

As illustrated in FIG. 8, a pair of connection interfaces 36 is defined on the connecting wall 303. As illustrated in FIG. 10, the one end of the electrical connection wire 400 is inserted to the connection interfaces 36, so that the first device 200 can be connected to other device, such as the second device 500. In this way, the electrical groove 16, the pair of plugs 18, the electrical recess 33 and the pair of connection interfaces 36 form the electrical connection channel.

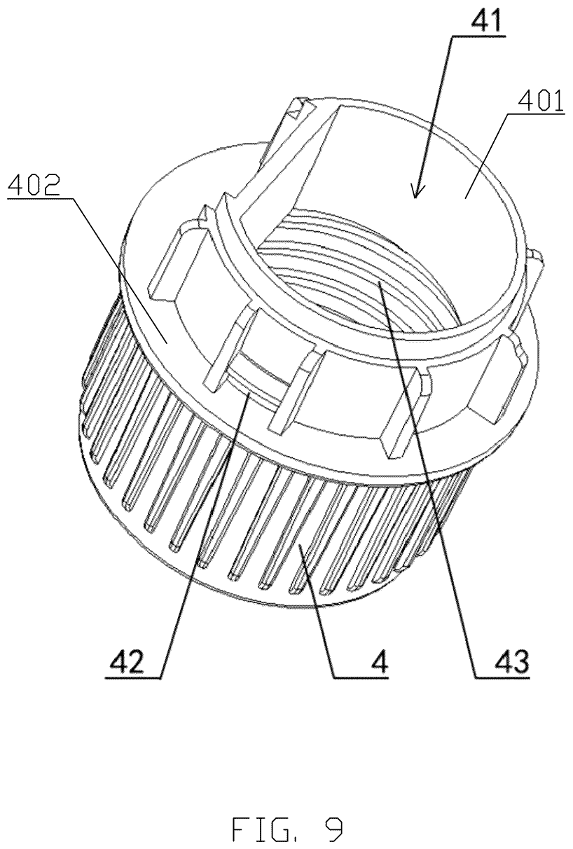

As illustrated in FIG. 9, the second connector 4 is fixed to the electrical connector 3. A third embedded portion 401 extends axially from the end of the second connector 4 and is connected with second connector 4 through a connected wall 402.

a fourth via hole 41 is defined in the second connector 4, and the first via hole 11, the second via hole 21, the third via hole 31, and the fourth via hole 41 cooperate to form the gas channel. An end of the inner wall of the third embedded portion 401 is provided with an internal thread 43, and the second connector 4 is connected to the connecting pipeline 300 through the internal thread 43. A second connector groove 42 is defined on a side face of the third embedded portion 401, and the second connector groove 42 is fitted with the cantilevers 35, so that the second connector 4 is snap-fitted with the electrical connector 3.

As illustrated in FIG. 10, FIG. 12 to FIG. 13, during normal use, first, clamp and fix the first connector 1, the fixed connector 2, and the electrical connector 3, and then connect the electrical connection wire on a side of the pipeline with the plug 18. Then connect the second connector 4 with the electrical connector 3 to fix the connecting pipeline 300. When the connector assembly 100 is used for connection, the gas channel and the electrical connection channel can be formed at the same time, thus improving the connection efficiency. Furthermore, the electrical connection channel and the gas channel are divided into two parts, which can prevent the objects passing through the gas channel from affecting the electrical connection channel and improve the safety of use.

The foregoing descriptions are merely exemplary embodiments of the present disclosure, and are not intended to limit the patent scope of the present disclosure. Any equivalent structural transformation made by using the description and the accompanying drawings of the present disclosure, or direct or indirect application in other related technical fields, shall belong to the patent scope of protection of the present disclosure.

What is claimed is:

1. A connector assembly configured to connect a device by a connecting pipeline, and electrically connect the device to an electrical connection wire, the device comprising a pipeline interface and an electric interface, the connector assembly comprising:
a first connector having an end configured to connect to the pipeline interface and electrically connect to the electric interface,
a fixed connector,
an electric connector configured to be connected to the electrical connection wire, and
a second connector, a first end of the second connector being configured to connect to the connecting pipeline,
wherein the first connector is fixed to the electrical connector, the fixed connector is clamped between the first connector and the electrical connector, and a second end of the second connector is arranged at an end of the electrical connector and clamped with the electrical connector,
a first via hole, a second via hole, a third via hole, and a fourth via hole are defined in the first connector, the fixed connector, the electrical connector and the second connector, respectively, the first via hole, the second via hole, the third via hole, and the fourth via hole cooperatively form a gas channel.

2. The connector assembly according to claim 1, wherein an end of the first connector is provided with a connection ring and a connection plate,
a first groove is defined on a side of the connection ring away from the connection plate, and a second groove is provided on a side of the connection plate away from the connection ring, the first connector is configured to be fixedly clamped with the device through the first groove and the second groove.

3. The connector assembly according to claim 2, wherein the connection ring is further provided with a positioning bump.

4. The connector assembly according to claim 1, wherein the first connector further comprises a snap groove, the snap groove is L-shaped,
an inner side surface of the fixed connector is provided with a fixed block engaged with the snap groove.

5. The connector assembly according to claim 4, wherein a bottom surface of the fixed connector comprises at least one installation member, the electrical connector is defined with at least one fixed slot, the at least one fixed slot is engaged with the installation member.

6. The connector assembly according to claim 2, wherein an electrical groove is defined between the connection ring and the connection plate, an electrical connection contact for electrically connecting the connector to the device is arranged in the electrical groove.

7. The connector assembly according to claim 6, wherein the first connector comprises a mounting wall and a pair of plugs disposed on the mounting wall, the pair of plugs are configured to connect to the electrical connection contact,
two electrical recesses are provided on the electrical connector, the pair of plugs are inserted into the electrical recess.

8. The connector assembly according to claim 1, wherein two cantilevers are oppositely arranged on a bottom of the electrical connector, a second connector groove is defined on a side of the second connector, and the second connector groove is engaged with the two cantilevers.

9. The connector assembly according to claim 8, wherein the second connector comprises an inner wall and an internal thread defined on an end of the inner wall.

10. The connector assembly according to claim 1, wherein the second connector comprises an inner wall and an internal thread defined on an end of the inner wall.

11. The connector according to claim 2, wherein the first connector further comprises a snap groove, the snap groove is L-shaped, an inner side surface of the fixed connector is provided with a fixed block engaged with the snap groove.
